(19) United States
(12) Patent Application Publication
(10) Pub. No.: US 2025/0265498 A1
(43) Pub. Date: Aug. 21, 2025

(54) LEARNING APPARATUS

(71) Applicant: NEC Corporation, Tokyo (JP)

(72) Inventor: Takehiko MIZOGUCHI, Tokyo (JP)

(73) Assignee: NEC Corporation, Tokyo (JP)

(21) Appl. No.: 19/036,534

(22) Filed: Jan. 24, 2025

(30) Foreign Application Priority Data
Feb. 19, 2024 (JP) 2024-022934

(51) Int. Cl. G06N 20/00

(52) U.S. Cl. CPC G06N 20/00

(57) ABSTRACT

A learning apparatus includes an extracting unit that extracts a feature value in accordance with input data, a selecting unit that selects a set of feature values to be used when learning a model, from a feature value group including a plurality of the feature values extracted by the extracting unit, and a learning unit that learns the model using the set of feature values selected by the selecting unit. The selecting unit selects, from the feature value group, the set of feature values in which at least one of a distance between the labels given to the feature values or a distance between the feature values in a feature space satisfies a predetermined condition. Consequently, the learning apparatus can perform machine learning appropriately even in the case where there is a predetermined relation such as an order relation in the labels, and can support decision-making more appropriately.

### INCORPORATION BY REFERENCE

This application is based upon and claims the benefit of priority from Japanese patent application No. 2024-022934, filed on Feb. 19, 2024, the disclosure of which is incorporated herein in its entirety by description.

### TECHNICAL FIELD

The present invention relates to a learning apparatus, a learning method, and a storage medium.

### BACKGROUND ART

A technology used to perform machine learning using feature values extracted from time-series data is known.

For example, Patent Literature 1 discloses an apparatus that learns a model for extracting a feature value preserving a similarity relation of time-series data for training. For example, according to Patent Literature 1, the apparatus selects a triplet including an anchor sample, a positive sample of a class that is the same as that of the anchor sample, and a negative sample of a class different from that of the anchor sample. Then, the apparatus performs learning of the model so that samples of the same class are close in the feature space, and samples of the different classes are far away in the feature space.

Further, a related technique is disclosed in Patent Literature 2. Patent Literature 2 discloses an apparatus that performs learning so as to be able to store the order relation of the labels. According to Patent Literature 2, the apparatus selects a quadruplet including an anchor sample, a positive sample, and a negative sample 1 and a negative sample 2 each having a different label from the anchor sample. Then, the apparatus performs learning of the model using the selected quadruplet so that a predetermined loss is minimized. For example, such a configuration may enable feature extraction that takes into account the order when an order relation exists in the labels.
[Patent Literature 1] WO 2020/049666 A
[Patent Literature 2] JP 2023-538190 A

### SUMMARY

When the technique described in Patent Literature 1 is used, it is difficult to perform feature extraction that preserves the order relation existing in the labels. Therefore, it is desirable to use the technique described in Patent Literature 2 instead of Patent Literature 1 when preserving the order relation. On the other hand, in an attempt to select a set such as a quadruplet as described in Patent Literature 2, the number of combinations of the sets to be selected at the time of learning becomes enormous. As a result, there has arisen a problem that learning may take time, and it may be difficult to perform proper learning when there is a predetermined relation such as an order relation among the labels.

Accordingly, an example object of the present invention is to provide a learning method, a learning apparatus, and a recording medium that can solve the aforementioned problem.

In order to achieve the example object, a learning apparatus, according to one aspect of the present disclosure, is configured to include
an extracting unit that extracts a feature value in accordance with input data,
a selecting unit that selects a set of feature values to be used when learning a model, from a feature value group including a plurality of the feature values extracted, and
a learning unit that learns the model using the selected set of feature values.

The selecting unit is configured to select, from the feature value group, the set of feature values in which at least one of a distance between labels given to feature values or a distance between feature values in a feature space satisfies a predetermined condition.

Further, a learning method, according to another aspect of the present disclosure, is configured to include, by an information processing apparatus,
extracting a feature value in accordance with input data;
selecting a set of feature values to be used when learning a model, from a feature value group including a plurality of extracted feature values; and
learning the model using the selected set of feature values.

When selecting the set of feature values, the information processing apparatus selects, from the feature value group, the set of feature values in which at least one of a distance between labels given to feature values or a distance between feature values in a feature space satisfies a predetermined condition.

Further, a storage medium according to another aspect of the present disclosure is a computer-readable medium storing thereon a program for causing an information processing apparatus to execute processing to:
extract a feature value in accordance with input data;
select a set of feature values to be used when learning a model, from a feature value group including a plurality of the feature values extracted; and
learn the model using the selected feature values, wherein
the selecting the set of feature values includes selecting, from the feature value group, the set of feature values in which at least one of a distance between labels given to feature values or a distance between feature values in a feature space satisfies a predetermined condition.

According to each configuration as described above, the aforementioned problem can be solved.

### BRIEF DESCRIPTION OF THE DRAWINGS

FIG. 1 is a diagram illustrating an overview of a learning apparatus according to a first example embodiment of the present disclosure;

FIG. 2 is a diagram for describing the overview of the learning apparatus;

FIG. 3 is a block diagram illustrating an example configuration of the learning apparatus;

FIG. 4 is a diagram illustrating an example of processing by a feature value selecting unit;

FIG. 5 is a diagram illustrating another example of processing by the feature value selecting unit;

FIG. 6 is a flowchart illustrating an example of operation of the learning apparatus;

FIG. 7 is a block diagram illustrating another example configuration of the learning apparatus;

FIG. 8 is a diagram illustrating an example of application of the learning apparatus;

FIG. 9 is a diagram illustrating an example of application of the learning apparatus;

FIG. 10 is a diagram illustrating an estimation example when the learning apparatus described in the present disclosure is not used;

FIG. 11 is a diagram illustrating an estimation example when the learning apparatus described in the present disclosure is used;

FIG. 12 is a diagram illustrating another example of application of the learning apparatus;

FIG. 13 is a diagram illustrating an example of a hardware configuration of a learning apparatus according to a second example embodiment of the present disclosure;

FIG. 14 is a block diagram illustrating an example configuration of the learning apparatus; and

FIG. 15 is a flowchart illustrating an example of operation of the learning apparatus.

### EXEMPLARY EMBODIMENTS

### First Example Embodiment

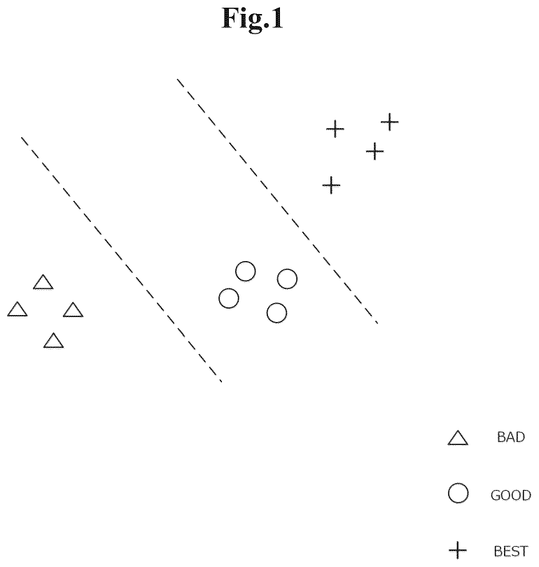

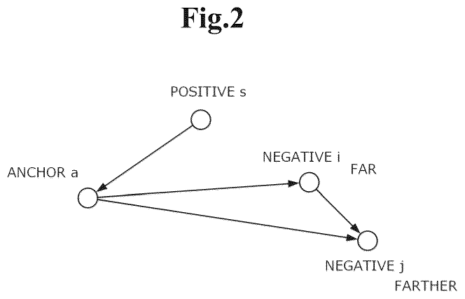

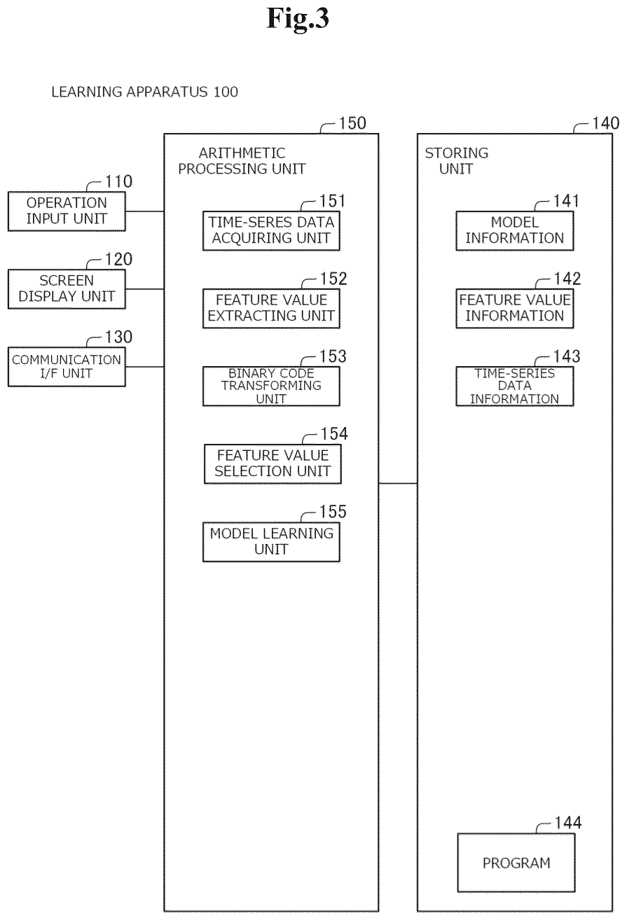

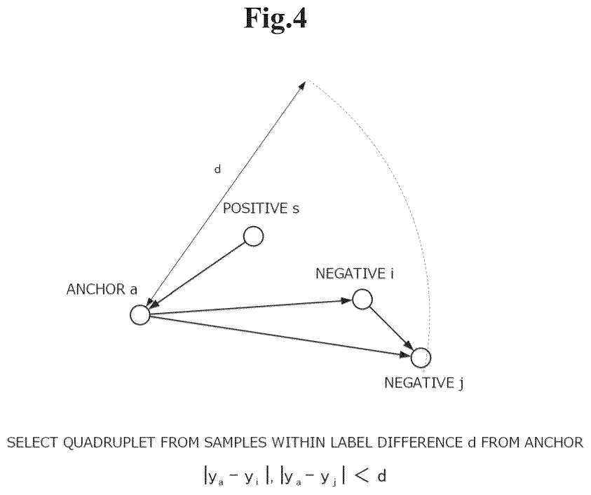

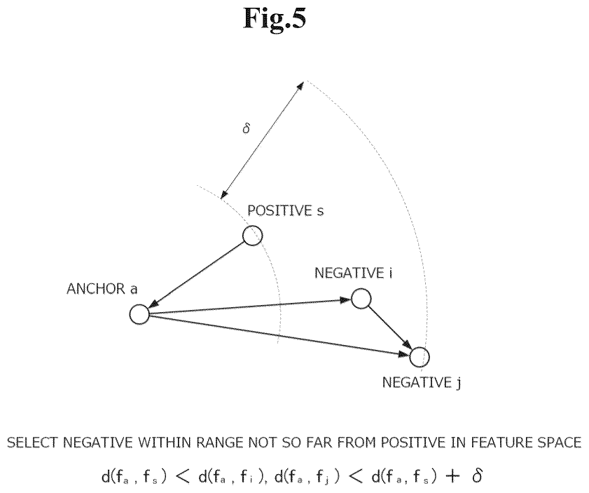

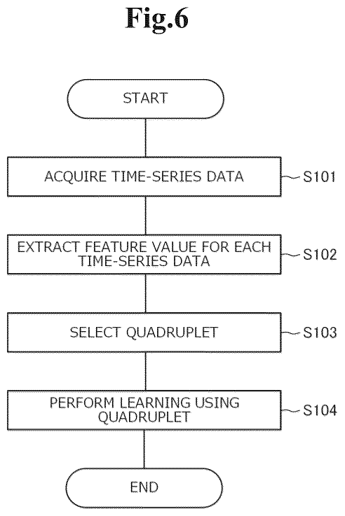

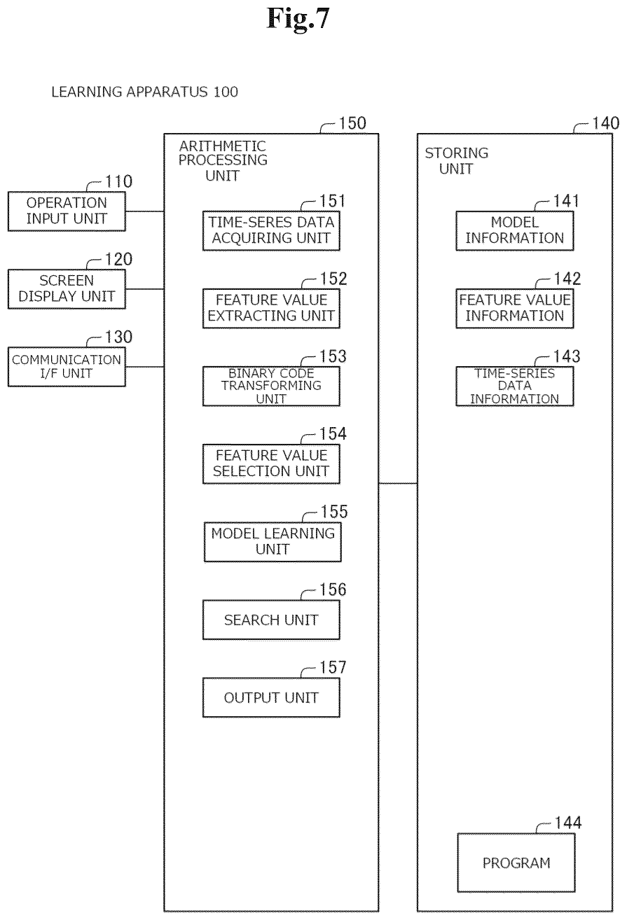

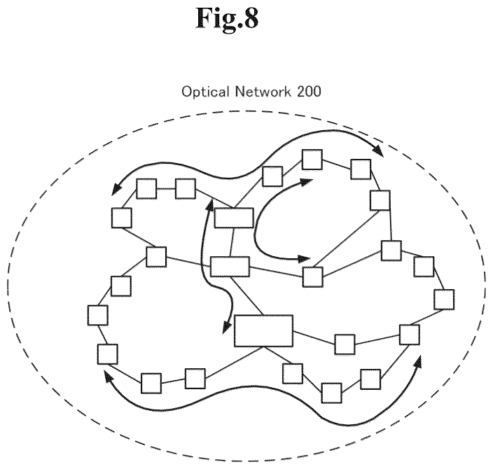

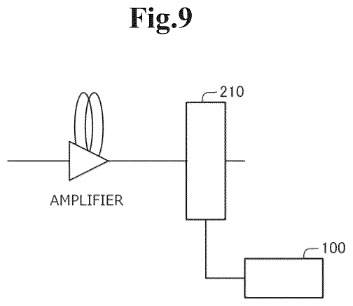

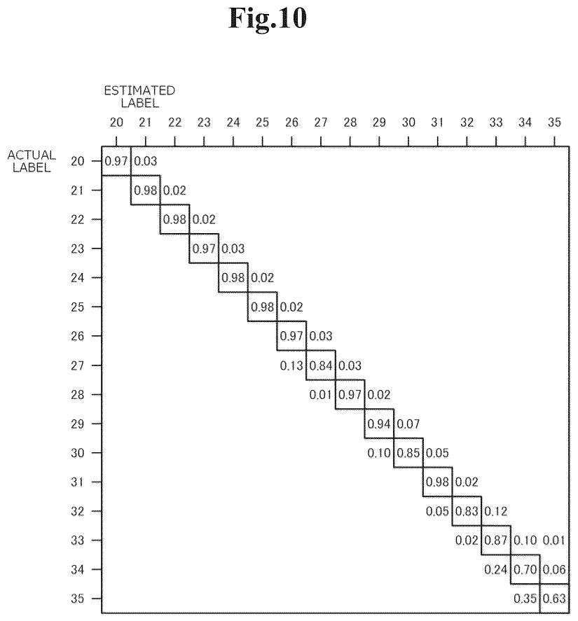

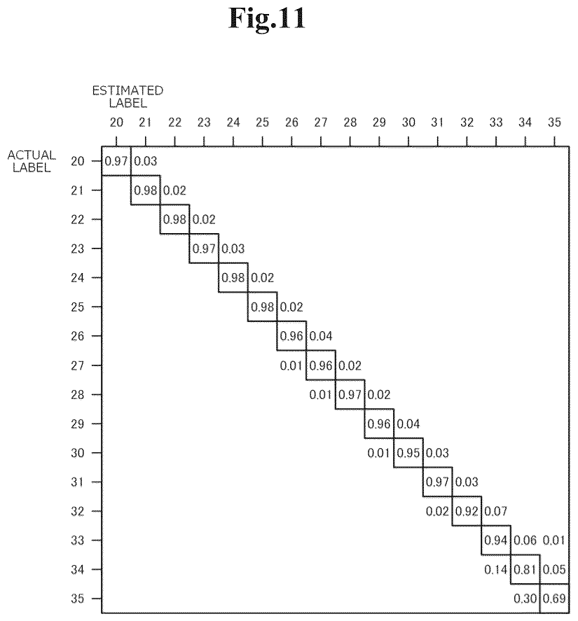

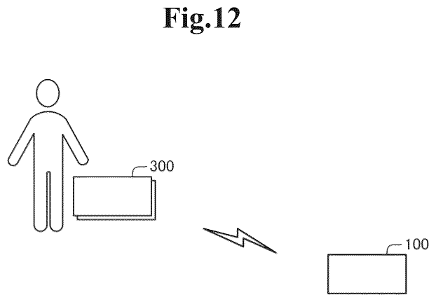

A first example embodiment of the present invention will be described with reference to FIGS. 1 to 12. FIGS. 1 and 2 are diagrams for describing the overview of a learning apparatus 100. FIG. 3 is a block diagram illustrating an example configuration of the learning apparatus 100. FIGS. 4 and 5 are diagrams illustrating an example of processing by a feature value selecting unit 154. FIG. 6 is a flowchart illustrating an example of operation of the learning apparatus 100. FIG. 7 is a block diagram illustrating another example configuration of the learning apparatus 100. FIGS. 8 and 9 are diagrams illustrating an example of application of the learning apparatus 100. FIG. 10 is a diagram illustrating an estimation example when the learning apparatus 100 is not used. FIG. 11 is a diagram illustrating an estimation example when the learning apparatus 100 is used. FIG. 12 is a diagram illustrating another example of application of the learning apparatus 100. In the present disclosure, the drawings may be associated with one or a plurality of example embodiments.

In the first example embodiment of the present disclosure, the learning apparatus 100 capable of performing learning that takes into account an order relation, when there is an order relation in the labels, will be described. For example, there may be an order relation among labels such as bad, good, best, and the like as illustrated in FIG. 1. In such a case, the learning apparatus 100 selects a quadruplet including an anchor sample, a positive sample having the same label as the anchor sample, a negative sample 1 and a negative sample 2 each having a label different from that of the anchor sample. Then, the learning apparatus 100 learns the model such that a predetermined loss is minimized by using the selected quadruplet. For example, the learning apparatus 100 performs learning of the model such that the negative sample 1 whose label is different from the label of the anchor sample but is closer to the label of the positive sample than the negative sample 2, to be far away in the feature space. Further, the learning apparatus 100 performs learning of the model such that the negative sample 2 whose label is farther from the of the positive sample than the negative sample 1, to be farther than the negative sample 1 in the feature space. For example, by performing such learning, the learning apparatus 100 performs learning that can preserve the order relation among the labels.

Further, the learning apparatus 100 in the present disclosure selects the quadruplet described above from among objects satisfying a predetermined condition. For example, the learning apparatus 100 selects a quadruplet including the negative sample 1, the negative sample 2, and the like from the feature values in which the label difference from the anchor sample is within a predetermined value d. In other words, the learning apparatus 100 can select a quadruple while imposing a limitation based on the distance between labels. In addition, the learning apparatus 100 may select a quadruple including the negative sample 1, the negative sample 2, and the like from the feature values in which the distance from the positive sample is within a predetermined value 8 in the feature value space, instead of the selection based on the distance between the labels described above. In other words, the learning apparatus 100 can select a quadruplet while imposing a limitation based on the distance between the feature values. For example, by performing selection on which a limitation is imposed in accordance with the distance between the labels or the distance between the feature values as described above, the learning apparatus 100 can make efficient selection of a quadruplet with narrowed objects to be selected. The learning apparatus 100 may be configured to determine a method to be used when selecting a quadruplet according to a predetermined condition. For example, the learning apparatus 100 can be configured to determine a method of selecting a quadruplet in accordance with whether or not there is a predetermined relation between the label and input data, such as a relation in which when the label is close, the data is also close.

After selecting a quadruplet while imposing a predetermined limitation by the method described above, the learning apparatus 100 can perform learning using any method such that the negative sample 1 is far away and the negative sample 2 is farther away in the feature space (see FIG. 2). For example, the learning apparatus 100 may perform learning using a method as described in Patent Literature 2. As an example, the learning apparatus 100 can perform learning of the model such that the loss indicated by Expression 1 is minimized.

$$ℓ = {\sum }_{( a , s , i , j )} {ℓ}_{a , s , i}^{tri} + {ℓ}_{a , s , j}^{t r i} + {λ}_{lr} {ℓ}_{a , s , i , j}^{lr} \qquad [ Expression 1 ]$$

$$\begin{matrix}{ℓ}_{a , s , i}^{tri} = {( ‖ {f}_{a} - {f}_{s} ‖ - ‖ {f}_{a} - {f}_{i} ‖ + α )}_{+} & \\ {ℓ}_{a , s , j}^{tri} = {( ‖ {f}_{a} - {f}_{s} ‖ - ‖ {f}_{a} - {f}_{j} ‖ + α )}_{+} & {( \cdot )}_{+} = max ( 0 , \cdot ) \\ {ℓ}_{a , s , i , j}^{lr} = {( log \frac{‖ {f}_{a} - {f}_{i} ‖}{‖ {f}_{a} - {f}_{j} ‖} - log \frac{‖ {y}_{a} - {y}_{i} ‖}{‖ {y}_{a} - {y}_{j} ‖} )}^{2} & \end{matrix} \qquad [ Expression 2 ]$$

Here, “a” represents the anchor sample, and “s” represents the positive sample. In addition, “i” represents the negative sample 1, and “j” represents the negative sample 2.

Hereinafter, an example configuration of the learning apparatus 100 will be described more specifically. The learning apparatus 100 is an information processing apparatus that can learn a model using a supervised metric learning method as described above. For example, the learning apparatus 100 acquires a time-series data set by acquiring time-series data from various sensors and other devices. Further, the learning apparatus 100 learns or updates the model based on a time-series data set including one or a plurality of pieces of time-series data.

FIG. 3 illustrates an example configuration of the learning apparatus 100. Referring to FIG. 3, the learning apparatus 100 includes, as main components, an operation input unit 110, a screen display unit 120, a communication I/F unit 130, a storing unit 140, and an arithmetic processing unit 150, for example.

FIG. 3 illustrates the case of realizing the functions as the learning apparatus 100 using one information processing apparatus. However, at least part of the functions as the learning apparatus 100 may be realized using a plurality of information processing apparatuses, such as realized on a cloud, for example. Moreover, the learning apparatus 100 may not include part of the above-illustrated configuration, such as not having the operation input unit 110 or the screen display unit 120, and may have a configuration other than the above-illustrated configuration.

The operation input unit 110 is configured of operation input devices such as a keyboard and a mouse. The operation input unit 110 detects an operation by an operator who operates the learning apparatus 100, and outputs it to the arithmetic processing unit 150.

The screen display unit 120 is configured of a screen display device such as a liquid crystal display or an organic EL (electro-luminescence). The screen display unit 120 can display on a screen a variety of information stored in the storing unit 140, and the like, in accordance with an instruction from the arithmetic processing unit 150.

The communication I/F unit 130 is configured of a data communication circuit and the like. The communication I/F unit 130 performs data communication with various sensors and other external devices connected via communication lines.

The storing unit 140 is a storage device such as a hard disk or a memory. The storing unit 140 stores processing information and a program 144 necessary for various processing by the arithmetic processing unit 150. The program 144 realizes various processing units by being read and executed by the arithmetic processing unit 150. The program 144 is loaded in advance from an external device or a recording medium via a data input/output function such as the communication I/F unit 130, and stored in the storing unit 140. Main information stored in the storing unit 140 includes, for example, model information 141, feature value information 142, time-series data information 143, and the like.

The model information 141 includes information on a model that extracts and outputs feature values preserving a local distance relation with respect to an input of a time-series segment. For example, the model information 141 may include a weight parameter or the like included in the trained model as described above. For example, the model included in the model information 141 is trained in advance using a time-series segment for training inside or outside the learning apparatus 100, and is stored in the storing unit 140. Moreover, the model information 141 is updated by learning by a model learning unit 155 which will be described later.

The feature value information 142 includes information corresponding to a feature value extracted from a time-series segment. For example, the feature value information 142 includes a binary code in which a feature value is transformed using any method, and the like. In the feature value information 142, a binary code may be associated with a label to be classified or the like. For example, the binary code included in the feature value information 142 is acquired using a method such as a binary code transforming unit 153 transforming the feature value extracted by a feature value extracting unit 152, and is stored in the storing unit 140.

In addition, the feature value information included in the feature value information 142 can be used in performing a search process which will be described later. For example, the result of the search process may be used to determine presence or absence of an anomaly and to determine a label to which it belongs. The result of the search process may also be used for purposes other than those illustrated above.

The time-series data information 143 includes a time-series data set including one or a plurality of pieces of time-series data. Here, the time-series data may be, for example, data in which pieces of numerical data such as observation data, measured by a sensor at predetermined periods, are arranged in order of the measurement time. The time-series data information 143 is updated in response to acquisition of time-series data from the sensor or other devices by a time-series data acquiring unit 151 to be described later.

The arithmetic processing unit 150 includes an arithmetic logic unit such as a CPU (Central Processing Unit) and peripheral circuits thereof. The arithmetic processing unit 150 loads the program 144 from the storing unit 140 and executes it, thereby making the above hardware and the program 144 to cooperate and realizing various processing units. Main processing units realized by the arithmetic processing unit 150 include, for example, the time-series data acquiring unit 151, the feature value extracting unit 152, the binary code transforming unit 153, a feature value selecting unit 154, and the model learning unit 155.

The arithmetic processing unit 150 may have a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the aforementioned CPU.

The time-series data acquiring unit 151 acquires a time-series data set by acquiring time-series data from various sensors and other devices. For example, the time-series data acquiring unit 151 can acquire time-series data from an optical transponder, an optical performance monitor measuring optical signal to noise ratio (OSNR) or the like, a plurality of sensors installed in a plant, a data center, and the like, various sensors related to healthcare such as blood pressure and heart rate, and any other devices.

Moreover, the time-series data acquiring unit 151 stores the acquired time-series data set as the time-series data information 143 into the storing unit 140.

The feature value extracting unit 152 inputs a time-series segment into the model stored as the model information 141, thereby extracting a feature value from the time-series segment. For example, the feature value extracting unit 152 divides the time-series data set acquired by the time-series data acquiring unit 151 into a plurality of time-series segments using a time window of a certain period. Then, the feature value extracting unit 152 inputs each of the divided time-series segments into the trained model, thereby extracting a feature value. The feature value extracting unit 152 may perform the division into time-series segments using any method. For example, the size of the time window may be set to any size. Moreover, the feature value extracting unit 152 may divide the time-series data into a plurality of time-series segments so as to allow overlapping for any period, or may divide the time-series data into a plurality of time-series segments so as to avoid overlapping of the time-series segments.

The binary code transforming unit 153 transforms the feature value extracted by the feature value extracting unit 152 into a binary code that is information corresponding to the feature value. In the present disclosure, there is no particular limitation on a method for transforming into a binary code. The binary code transforming unit 153 may transform the feature value extracted by the feature value extracting unit 152 into a binary code using any method. Moreover, the binary code transforming unit 153 can store the binary code obtained by transformation as the feature value information 142 into the storing unit 140.

Moreover, the feature value extracting unit 152 or the binary code transforming unit 153 may assign a label, serving as a classification target, to the feature value or the binary code using any method. For example, the feature value extracting unit 152 or the binary code transforming unit 153 may assign, to the feature value or the like, a label determined in accordance with the Euclidean distance between the time-series segment from which the feature value is extracted and the time-series segment to be compared stored in advance. Information about the label may be acquired in accordance with an operator's operation or the like on the operation input unit 110.

The feature value selecting unit 154 selects a set of feature values such as a quadruplet to be used for learning from a feature value group including a plurality of feature values extracted by the feature value extracting unit 152. As described above, the feature value selecting unit 154 selects a quadruplet after imposing a predetermined limitation such as a distance between labels or a distance between feature values. The feature value selecting unit 154 can select a plurality of quadruplets by repeating the above selection.

For example, the feature value selecting unit 154 can select a quadruplet after imposing a limitation based on the distance between the labels as illustrated in FIG. 4. To be specific, the feature value selecting unit 154 selects an anchor sample by selecting a feature value at random from a feature value group including a plurality of feature values extracted by the feature value extracting unit 152, and also selects a positive sample from feature values with the same labels as the anchor sample. Moreover, the feature value selecting unit 154 selects a negative sample 1 and a negative sample 2 from feature values in which the label difference from the selected anchor sample is within a predetermined value d from among the feature values included in the feature value group. That is to say, the feature value selecting unit 154 selects the negative sample 1 and the negative sample 2 satisfying an expression indicated by Expression 3. At this time, the feature value selecting unit 154 performs the selection such that the label difference between the anchor sample and the negative sample 2 is greater than the label difference between the anchor sample and the negative sample 1. That is to say, the feature value selecting unit 154 selects the negative sample 1 and the negative sample 2 satisfying the above limitation and with different labels given.

$$\vert {y}_{a} - {y}_{i} \vert , \vert {y}_{a} - {y}_{j} \vert < d \qquad [ Expression 3 ]$$

Note that “a” represent the anchor sample, “i” represents the negative sample 1, and “j” represents the negative sample 2.

Moreover, the feature value selecting unit 154 may select a quadruplet after imposing a limitation based on the distance between feature values in the feature space as illustrated in FIG. 5. To be specific, the feature value selecting unit 154 selects an anchor sample by selecting a feature value at random from a feature value group including a plurality of feature values extracted by the feature value extracting unit 152, and also selects a positive sample from the feature values with the same labels as the anchor sample. Moreover, the feature value selecting unit 154 selects the negative sample 1 and the negative sample 2 from the feature values in which the distance from the positive sample is within a predetermined value 8 in the feature value space, among the feature values included in the feature value group. That is to say, the feature value selecting unit 154 selects the negative sample 1 and the negative sample 2 satisfying an expression indicated by Expression 4. At this time, the feature value selecting unit 154 performs the selection such that the label difference between the anchor sample and the negative sample 2 is greater than the label difference between the anchor sample and the negative sample 1. That is to say, the feature value selecting unit 154 selects the negative sample 1 and the negative sample 2 satisfying the above limitation and with different labels given.

$$d ( {f}_{a} , {f}_{s} ) < d ( {f}_{a} , {f}_{i} ) , d ( {f}_{a} , {f}_{j} ) < d ( {f}_{a} , {f}_{s} ) + δ \qquad [ Expression 4 ]$$

Note that “a” represent the anchor sample, and “s” represent the positive sample. In addition, “i” represents the negative sample 1, and “j” represent the negative sample 2.

For example, the feature value selecting unit 154 can select a quadruplet using either or both of the methods described above. The feature value selecting unit 154 may be configured to determine which of the above two methods is to be used, in accordance with whether or not there is a predetermined relation between the label and the time-series data that is input data. For example, the feature value selecting unit 154 can be configured to select a quadruplet after imposing a limitation based on the distance between the labels, in the case where it is determined that there is a predetermined relation between the label and the input data, that is, when the label is close, the time-series data is also close, for example. Moreover, the feature value selecting unit 154 can be configured to select a quadruplet after imposing a limitation based on the distance between the feature values in the feature space when it cannot be determined that there is a predetermined relation between the label and the input data. The feature value selecting unit 154 may determine a method to be used when selecting a quadruplet, in accordance with a condition other than those illustrated above. Moreover, the feature value selecting unit 154 may determine a method to be used when selecting a quadruplet in accordance with an operation using the operation input unit 110 or an instruction from an external device or the like.

In the case where a limitation based on the distance between labels is imposed, it is desirable for the feature value selecting unit 154 to select the negative sample 1 and the negative sample 2 in which the labels are separated in the same direction from the anchor sample. For example, in the case where there are labels such as “1”, “2”, “3”, “4”, and “5”, when the label of the anchor sample is “3”, it is desirable for the feature value selecting unit 154 to select the negative sample 1 and the negative sample 2 from among the feature values with labels having values smaller than the label “3”, or to select the negative sample 1 and the negative sample 2 from among the feature values with labels having values larger than the label “3”.

The model learning unit 155 performs learning using a quadruplet selected by the feature value selecting unit 154, thereby updating the model stored as the model information 141. As described above, the model learning unit 155 may learn the model using a supervised metric learning method as described in Patent Literature 2.

The above is an example configuration of the learning apparatus 100.

The model to be learned by the model learning unit 155 may be any model that can handle time-series data. For example, the model may be any of 1D-CNN (1 Dimensional-Convolutional Neural Network), GRU (Gated Recurrent Unit), LSTM (Long Short-Term Memory), Transformer, and the like.

In addition, the feature values used when selecting a quadruplet with a limitation based on the distance between the feature values may not necessarily be the feature values extracted from the latest model.

Next, an example of operation of the learning apparatus 100 will be described with reference to FIG. 6.

FIG. 6 illustrates an example of operation of the learning apparatus 100. Referring to FIG. 6, the time-series data acquiring unit 151 acquires a time-series data set by acquiring time-series data from various sensors included in the learning apparatus 100 and other devices (step S101).

The feature value extracting unit 152 inputs a time-series segment into the model stored as the model information 141, thereby extracting a feature value based on the time-series segment (step S102). For example, the feature value extracting unit 152 divides the time-series data set acquired by the time-series data acquiring unit 151 into a plurality of time-series segments using a time window of a certain period. Then, the feature value extracting unit 152 inputs each of the divided time-series segments into the trained model, thereby extracting a feature value.

The feature value selecting unit 154 selects a quadruplet used for learning from a feature value group including a plurality of feature values extracted by the feature value extracting unit 152 (step S103). As described above, the feature value selecting unit 154 selects a quadruplet after imposing a predetermined limitation such as a distance between labels or a distance between feature values.

The model learning unit 155 performs learning using the quadruplet selected by the feature value selecting unit 154, thereby updating the model stored as the model information 141 (step S104). As described above, the model learning unit 155 may learn the model using a supervised metric learning method as described in Patent Literature 2.

As described above, the learning apparatus 100 includes the feature value selecting unit 154 and the model learning unit 155. According to such a configuration, the model learning unit 155 can learn a model using a quadruplet efficiently selected by the feature value selecting unit 154. As a result, appropriate model learning can be realized more efficiently. In addition, as the number of labels increases, it is more likely to select a quadruplet that does not contribute to learning, such as the case where the labels of the negative samples are both far apart from the label of the anchor sample and the labels of the negative samples are also far apart from each other. Even in such a case, by using the feature value selecting unit 154, it is possible to realize learning that takes into account the order of the labels by performing more appropriate selection.

Note that the configuration of the learning apparatus 100 is not limited to the configuration illustrated with reference to FIG. 3. For example, the learning apparatus 100 may be configured of part of the configuration illustrated in FIG. 3, such as not having the binary code transforming unit 153. FIG. 7 illustrates another example configuration of the learning apparatus 100. Referring to FIG. 7, for example, the arithmetic processing unit 150 reads the program 144 from the storing unit 140 and executes it, thereby realizing a search unit 156 and an output unit 157 in addition to the configuration illustrated in FIG. 3.

The search unit 156 performs a search process based on a feature value extracted from a time-series segment that is a search target.

For example, when the time-series data acquiring unit 151 acquires a time-series data set that is a search target, the feature value extracting unit 152 divides the search target time-series data set into a plurality of time-series segments, thereby extracting a feature value. Moreover, the binary code transforming unit 153 transforms the feature value extracted by the feature value extracting unit 152 into a binary code that is information corresponding to the feature value. The search unit 156 acquires the binary code obtained by transformation as described above. Then, the search unit 156 searches the feature value information 142 for a binary code similar to the acquired binary code. For example, the search unit 156 calculates the distance between the acquired binary code and each of the binary codes included in the feature value information 142. Then, the search unit 156 acquires a binary code satisfying any condition, such as a binary code in which the calculated distance is the minimum among the binary codes included in the feature value information 142, as a binary code similar to the acquired binary code.

Further, the search unit 156 can perform a variety of processing according to the result of the search. For example, by identifying a label associated with the binary code acquired by the search, the search unit 156 can estimate a label of a time-series segment that is a search target. Moreover, the search unit 156 may detect an anomaly in accordance with the result of the search. For example, a binary code corresponding to time-series data at the time of anomaly is stored in advance in the feature value information 142. The search unit 156 calculates an anomaly score corresponding to the distance between a binary code that is a search target and a searched binary code. Then, the search unit 156 can detect an anomaly based on the calculated anomaly score. For example, the search unit 156 may detect an anomaly in accordance with the result of comparison between the calculated anomaly score and a predetermined threshold value. The search unit 156 may execute a process according to the result of the search other than those illustrated above.

The output unit 157 outputs the result of the search by the search unit 156, and the like. For example, the output unit 157 may output an estimated label, an anomaly score, and the like. The output unit 157 can display the search result and the like on the screen display unit 120, or transmit the search result and the like to an external device via the communication I/F unit. In addition, the output unit 157 may be configured to output information stored in the storing unit 140, such as the feature value information 142, in addition to the search result and the like.

Further, as described above, the learning apparatus 100 can select a quadruplet by extracting a feature value from time-series data acquired from an optical transponder, an optical performance monitor that measures an optical signal to noise ratio, a plurality of sensors installed in a plant, a data center, and the like, various sensors related to healthcare such as blood pressure and heart rate, and any other devices. For example, as illustrated in FIG. 8, the learning apparatus 100 may be configured to acquire time-series data from an optical transponder, an optical performance monitor, or the like owned by the optical network 200. As an example, as illustrated in FIG. 9, the learning apparatus 100 can be connected so as to be able to communicate with an optical transponder 210 that receives an optical signal via a connected optical fiber and transforms it into an electrical signal. In this case, the time-series data acquiring unit 151 of the learning apparatus 100 can acquire time-series data corresponding to the intensity of the optical signal acquired by the sensor or the like owned by the optical transponder 210. In addition to the example illustrated in FIG. 9, the optical transponder 210 itself may have a function as the learning apparatus 100 illustrated in FIG. 3.

FIGS. 10 and 11 are examples of estimation results when estimating the OSNR that is a label, in accordance with the time-series data acquired from the optical transponder 210. FIG. 10 illustrates an example of the estimation result when the learning apparatus 100 is not applied (when selection by the feature value selecting unit 154 is not performed), and FIG. 11 illustrates an example of the estimation result when the learning apparatus 100 is applied (when selection by the feature value selecting unit 154 is performed). Referring to FIGS. 10 and 11, it is found that the estimation performance is improved by applying the learning apparatus 100, especially in the area such as 30 dB or more. In other words, by using the learning apparatus 100, it is possible to improve the performance when performing ordered estimation such as estimation of the OSNR, and to realize more appropriate learning for performing more appropriate estimation.

Further, as illustrated in FIG. 12, the learning apparatus 100 may be applied to the field of healthcare. For example, the learning apparatus 100 can be configured to acquire time-series data from various medical care-related biosensors 300 such as a sphygmomanometer or a heart rate monitor owned by a subject such as a patient. In this case, the search unit 156 can be configured to estimate a label having an order relation corresponding to the level of health, a possibility of illness, and the like. By performing such estimation using the learning apparatus 100, more appropriate estimation can be realized, and it is possible to support decision-making by doctors and patients more appropriately.

The learning apparatus 100 is applicable to various situations as described above. For example, the learning apparatus 100 may be applied to situations other than the examples described above, such as a plant.

In the present disclosure, the case of selecting a quadruplet is illustrated. However, the present invention may be applied to a case other than the case of selecting a quadruplet. For example, the present invention may be applied to a learning apparatus that selects a triplet as disclosed in Patent Literature 1, or a learning apparatus that selects any combination such as a set of five or more. In addition, the present invention can be applied not only to the case where there is an order relation between labels, but also to the case where there is some kind of relation between labels, such as when there is a similarity relation between labels.

The present disclosure describes the case of extracting a feature value from time-series data. However, the present invention may be applied to the case of extracting a feature value from any data other than time-series data. That is to say, the learning apparatus 100 may be configured to extract a feature value in accordance with an input of any data other than time-series data.

### Second Example Embodiment

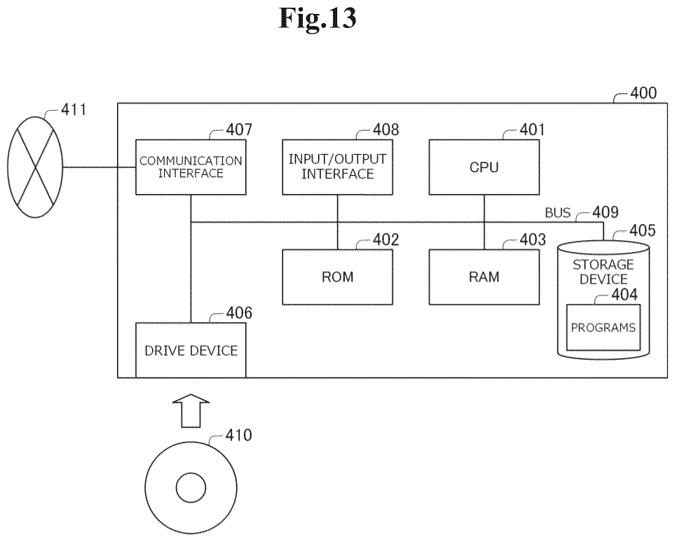

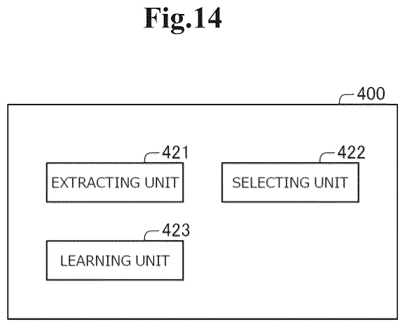

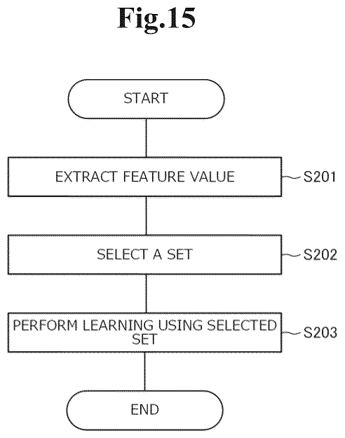

Next, a second example embodiment of the present disclosure will be described with reference to FIGS. 13 to 15. FIG. 13 is a diagram illustrating an example of a hardware configuration of a learning apparatus 400. FIG. 14 is a block diagram illustrating an example configuration of the learning apparatus 400. FIG. 15 is a flowchart illustrating an example of operation of the learning apparatus 400.

The second example embodiment of the present disclosure describes the learning apparatus 400 that is an information processing apparatus that performs machine learning by selecting a combination such as a quadruplet from a feature value group extracted from input data. FIG. 13 illustrates an example of a hardware configuration of the learning apparatus 400. Referring to FIG. 13, the learning apparatus 400 includes, as an example, the following hardware configuration:
a CPU (Central Processing Unit) 401 (arithmetic logic unit);
a ROM (Read Only Memory) 402 (memory unit);
a RAM (Random Access Memory) 403 (memory unit);
programs 404 loaded into the RAM 403;
a storage device 405 storing the programs 404;
a drive device 406 that performs reading from and writing into a recording medium 410 external to the information processing apparatus;
a communication interface 407 connected to a communication network 411 external to the information processing apparatus;
an input/output interface 408 that performs input/output of data; and
a bus 409 connecting the components.

Further, the learning apparatus 400 can realize functions as an extracting unit 421, a selecting unit 422, and a learning unit 423 shown in FIG. 14 by the CPU 401 acquiring the programs 404 and executing the programs 404. The programs 404 are, for example, stored in advance in the storage device 405 or the ROM 402, and are loaded into the RAM 403 or the like and executed by the CPU 401 as necessary. Moreover, the programs 404 may be provided to the CPU 401 via the communication network 411, or the programs may be stored in advance on the recording medium 410 and read out by the drive device 406 and provided to the CPU 401.

FIG. 13 illustrates an example of a hardware configuration of the learning apparatus 400. The hardware configuration of the learning apparatus 400 is not limited to the aforementioned case. For example, the learning apparatus 400 may be configured of part of the aforementioned configuration, such as not having the drive device 406. Further, the CPU 401 may be a GPU or the like illustrated in the first example embodiment.

The extracting unit 421 extracts a feature value in accordance with input data. For example, the extracting unit 421 can extract a feature value in accordance with input data such as time-series data acquired by various sensors being input to the trained model.

The selecting unit 422 selects a set of feature values to be used when learning the model, from a feature value group including a plurality of feature values extracted by the extracting unit 421. For example, the selecting unit 422 can select a quadruplet configured of an anchor sample, a positive sample, a first negative sample, and a second negative sample.

The learning unit 423 learns the model using a set of feature values selected by the selecting unit 422. For example, the learning unit 423 may learn the model so that the loss is minimized as described in Patent Literature 2.

The above is an example configuration of the learning apparatus 400. Next, an example of operation of the learning apparatus 400 will be described with reference to FIG. 15.

FIG. 15 is a flowchart illustrating an example of operation of the learning apparatus 400. Referring to FIG. 15, the extracting unit 421 extracts a feature value in accordance with input data (step S201).

The selecting unit 422 selects a set of feature values to be used when learning the model, from a feature value group including a plurality of feature values extracted by the extracting unit 421 (step S202). For example, the selecting unit 422 can select a quadruplet configured of an anchor sample, a positive sample, a first negative sample, and a second negative sample.

The learning unit 423 learns the model using the set of feature values selected by the selecting unit 422 (step S203).

The above is an example of operation of the learning apparatus 400.

As described above, the learning apparatus 400 includes the selecting unit 422 and the learning unit 423. According to such a configuration, the learning unit 423 can learn a model using the feature values selected by the selecting unit 422. As a result, appropriate model learning can be realized more efficiently.

The learning apparatus 400 described above can be realized by incorporating a predetermined program into an information processing apparatus such as the learning apparatus 400. To be specific, a program as another aspect of the present invention is a program for causing an information processing apparatus such as the learning apparatus 400 to execute processes to: extract a feature value in accordance with input data; select a set of feature values to be used when learning a model, from a feature value group including a plurality of extracted feature values; learn the model using the selected set of feature values; and when selecting the set of feature values, select a set of feature values in which at least one of a distance between labels given to the feature values or a distance between feature values in a feature space satisfies a predetermined condition.

Further, a learning method executed by an information processing apparatus such as the learning apparatus 400 described above is a method including: extracting a feature value in accordance with input data; selecting a set of feature values to be used when learning the model, from a feature value group including a plurality of extracted feature values; learning a model using the selected set of feature values; and when selecting the set of feature values, selecting a set of feature values in which at least one of a distance between labels given to the feature values or a distance between features in the feature space satisfies a predetermined condition.

Even in the invention of a program, or a computer-readable recording medium with a program recorded, or a learning method having the above-described configuration, the object of the present disclosure described above can be achieved because the same action and effect as those of the learning apparatus 400 described above are achieved.

### <Supplementary Note>

The whole or part of the example embodiments disclosed above can be described as the following supplementary notes. Hereinafter, the overview of the learning apparatus and the like in the present invention will be described. However, the present invention is not limited to the following configuration.

### (Supplementary Note 1)

A learning apparatus comprising:
an extracting unit that extracts a feature value in accordance with input data;
a selecting unit that selects a set of feature values to be used when learning a model, from a feature value group including a plurality of the feature values extracted; and
a learning unit that learns the model using the selected set of feature values, wherein
the selecting unit selects, from the feature value group, the set of feature values in which at least one of a distance between labels given to feature values or a distance between feature values in a feature space satisfies a predetermined condition.

### (Supplementary Note 2)

The learning apparatus according to supplementary note 1, wherein
the selecting unit selects the set of feature values from the feature value group by imposing a limitation based on the distance between the labels given to the feature values.

### (Supplementary Note 3)

The learning apparatus according to supplementary note 2, wherein
the selecting unit selects an anchor sample from the feature value group, and selects at least one negative sample having a label in which a difference from a label given to the anchor sample is within a predetermined value and which is different from the label given to the selected anchor sample, from among the feature values included in the feature value group.

### (Supplementary Note 4)

The learning apparatus according to supplementary note 3, wherein
the selecting unit selects a first negative sample and a second negative sample each having a label in which a difference from the label given to the anchor sample is within a predetermined value and which is different from the label given to the selected anchor sample, from among the feature values included in the feature value group.

### (Supplementary Note 5)

The learning apparatus according to supplementary note 4, wherein
the selecting unit selects the first negative sample and the second negative sample having the labels that are separated in a same direction from the anchor sample.

### (Supplementary Note 6)

The learning apparatus according to any one of supplementary notes 1 to 5, wherein
the selecting units determines whether to select the set of feature values in which the distance between the labels satisfies a condition, or select the set of feature values in which the distance between the feature values in the feature space satisfies a condition, in accordance with a relation between the input data and the labels.

### (Supplementary Note 7)

The learning apparatus according to supplementary note 6, wherein
the selecting unit determines to select the set of feature values in which the distance between the labels satisfies a condition, when there is a predetermined relation between the input data and the labels.

### (Supplementary Note 8)

The learning apparatus according to any one of supplementary notes 1 to 7, wherein
the selecting unit selects a quadruplet from the feature value group, the quadruplet including an anchor sample, a positive sample with a label that is same as a label of the anchor sample, and a first negative sample and a second negative sample each of which has a label that is different from the label of the anchor sample and in which at least one of a distance between the labels or a distance between the feature values in a feature space satisfies a predetermined condition.

### (Supplementary Note 9)

A learning method performed by an information processing apparatus, the method comprising:
extracting a feature value in accordance with input data;
selecting a set of feature values to be used when learning a model, from a feature value group including a plurality of the feature values extracted; and
learning the model using the selected set of feature values, wherein
when selecting the set of feature values, the information processing apparatus selects, from the feature value group, the set of feature values in which at least one of a distance between labels given to feature values or a distance between feature values in a feature space satisfies a predetermined condition.

### (Supplementary Note 10)

A program for causing an information processing apparatus to execute processing to:
extract a feature value in accordance with input data;
select a set of feature values to be used when learning a model, from a feature value group including a plurality of the feature values extracted; and
learn the model using the selected feature values, wherein
the selecting the set of feature values includes selecting, from the feature value group, the set of feature values in which at least one of a distance between labels given to feature values or a distance between feature values in a feature space satisfies a predetermined condition.

All or some of the configurations described in Supplementary Notes 2 to 8 dependent on the learning apparatus described in Supplementary Note 1 may be dependent on the learning method described in Supplementary Note 9 and the program described in Supplementary Note 10 by the same dependence. Furthermore, not limited to Supplementary Notes 9 and 10, within the scope of the respective example embodiments described above, some or all of the configurations described as supplementary notes may be dependent on various hardware, software, various recording means for recording software, or systems.

The programs described in the above example embodiments and supplementary notes may be stored in a storage device, or the programs may be recorded on a computer-readable recording medium. For example, the recording medium is a portable medium such as a flexible disk, an optical disk, a magneto-optical disk, or a semiconductor memory.

Although the present invention has been described above with reference to the above example embodiments, the present invention is not limited to the example embodiments described above. The configuration and details of the present invention can be changed in various manners that can be understood by those skilled in the art within the scope of the present invention.

### REFERENCE SIGNS LIST

100 learning apparatus
110 operation input unit
120 screen display unit
130 communication I/F unit
140 storing unit
141 model information
142 feature value information
143 time-series data information
144 program
150 arithmetic processing unit
151 time-series data acquiring unit
152 feature value extracting unit
153 binary code transforming unit
154 feature value selecting unit
155 model learning unit
156 search unit
157 output unit
200 optical network
210 optical transponder
300 biosensor
400 learning apparatus
401 CPU
402 ROM
403 RAM
404 programs
405 storage device
406 drive device
407 communication interface
408 input/output interface
409 bus
410 recording medium
411 communication network
421 extracting unit
422 selecting unit
423 learning unit

1. A learning apparatus comprising:
at least one memory configured to store instructions; and
at least one processor configured to execute instructions to:
extract a feature value in accordance with input data;
select a set of feature values to be used when learning a model, from a feature value group including a plurality of the feature values extracted; and
learn the model using the selected set of feature values, wherein
the selecting the set of feature values includes selecting, from the feature value group, the set of feature values in which at least one of a distance between labels given to feature values or a distance between feature values in a feature space satisfies a predetermined condition.

2. The learning apparatus according to claim 1, wherein the at least one processor is configured to execute the instructions to
select the set of feature values from the feature value group by imposing a limitation based on the distance between the labels given to the feature values.

3. The learning apparatus according to claim 2, wherein the at least one processor is configured to execute the instructions to
select an anchor sample from the feature value group, and select at least one negative sample having a label in which a difference from a label given to the anchor sample is within a predetermined value and which is different from the label given to the selected anchor sample, from among the feature values included in the feature value group.

4. The learning apparatus according to claim 3, wherein the at least one processor is configured to execute the instructions to
select a first negative sample and a second negative sample each having a label in which a difference from the label given to the anchor sample is within a predetermined value and which is different from the label given to the selected anchor sample, from among the feature values included in the feature value group.

5. The learning apparatus according to claim 4, wherein the at least one processor is configured to execute the instructions to
select the first negative sample and the second negative sample having the labels that are separated in a same direction as viewed from the anchor sample.

6. The learning apparatus according to claim 1, wherein the at least one processor is configured to execute the instructions to
determine whether to select the set of feature values in which the distance between the labels satisfies a condition, or select the set of feature values in which the distance between the feature values in the feature space satisfies a condition, in accordance with a relation between the input data and the labels.

7. The learning apparatus according to claim 6, wherein the at least one processor is configured to execute the instructions to
determine to select the set of feature values in which the distance between the labels satisfies a condition, when there is a predetermined relation between the input data and the labels.

8. The learning apparatus according to claim 1, wherein the at least one processor is configured to execute the instructions to
select a quadruplet from the feature value group, the quadruplet including an anchor sample, a positive sample with a label that is same as a label of the anchor sample, and a first negative sample and a second negative sample each of which has a label that is different from the label of the anchor sample and in which at least one of a distance between the labels or a distance between the feature values in a feature space satisfies a predetermined condition.

9. A learning method performed by an information processing apparatus, the method comprising:
extracting a feature value in accordance with input data;
selecting a set of feature values to be used when learning a model, from a feature value group including a plurality of extracted feature values; and
learning the model using the selected set of feature values, wherein
when selecting the set of feature values, the information processing apparatus selects, from the feature value group, the set of feature values in which at least one of a distance between labels given to feature values or a distance between feature values in a feature space satisfies a predetermined condition.

10. A non-transitory computer-readable medium storing thereon a program comprising instructions for causing an information processing apparatus to execute processing to:
extract a feature value in accordance with input data;
select a set of feature values to be used when learning a model, from a feature value group including a plurality of the feature values extracted; and
learn the model using the selected feature values, wherein
the selecting the set of feature values includes selecting, from the feature value group, the set of feature values in which at least one of a distance between labels given to feature values or a distance between feature values in a feature space satisfies a predetermined condition.
